(19) United States
(12) Patent Application Publication
(10) Pub. No.: US 2021/0089983 A1
(43) Pub. Date: Mar. 25, 2021

(54) VEHICLE RIDE-SHARING ASSIST SYSTEM

(71) Applicant: HONDA MOTOR CO., LTD., Minato-ku, Tokyo (JP)

(72) Inventors: Ryusuke TAMANAHA, Saitama (JP); Yasuhiro SAWADA, Saitama (JP); Isao UEMATSU, Saitama (JP); Nobuhiro SAKURAI, Saitama (JP)

(21) Appl. No.: 16/971,935

(22) PCT Filed: Jan. 17, 2019
(86) PCT No.: PCT/JP2019/001261

§ 371 Date: Aug. 21, 2020

(30) Foreign Application Priority Data
Feb. 23, 2018 (JP) 2018-030603

(51) Int. Cl. G06Q 10/06; H04W 4/40; H04W 4/02; G06F 16/51; G06F 16/61; G01S 19/01

(52) U.S. Cl. CPC G06Q 10/06311; H04W 4/40; G01S 19/01; G06F 16/51; G06F 16/61; H04W 4/02

(57) ABSTRACT

A vehicle ride-sharing assist system includes a user terminal, a vehicle terminal, and a host server. The host server includes a proximity notification unit for generating a proximity notification signal when a distance between a user and a ride-sharing vehicle becomes equal to or less than a prescribed value. The vehicle terminal includes a user response request unit for generating a user response request signal on receiving the proximity notification signal. The user terminal includes a user side notification/operation unit for notifying the user of a specific motion or cause the user terminal to perform a specific operation according to the user response request signal. The vehicle terminal further includes a user position identification unit for detecting the motion of the user or the operation of the user terminal and identifying a position of the user. A user position notification unit notifies the identified position to the driver.

### TECHNICAL FIELD

The present disclosure relates to a vehicle ride-sharing assist system for assisting in identification of a user to board a ride-sharing vehicle at a pickup point.

### BACKGROUND ART

There are known systems for assisting in ride-sharing of a shared vehicle by plural users. Patent Document 1 discloses a technique for improving the convenience of the ride-sharing by optimizing a setting method of a pickup point where the shared vehicle, which one member (the former boarding member) has boarded, picks up another member (the latter boarding member) on the way to the destination of the boarded member. This system selects candidates of the pickup point and thus prioritizes the candidates based on the ease with which the vehicle arrives at the pickup point and the ease with which the member waits at the pickup point. With regard to the former boarding member, the ease with which the vehicle arrives at the pickup point is set according to whether the pickup point present on an estimated travel route, a distance between the pickup point and the estimated travel route, and standards of roads (for example, national roads, prefectural roads/main local roads, city roads and their subclasses). Further, with regard to the latter boarding member, the ease with which the vehicle arrives at the pickup point is set according to the distance between the shared vehicle and the position where the latter boarding member is present immediately before the use of the shared vehicle. Further, this system presents the respective prioritized candidates of the pickup point to the latter boarding member and thus determines the pickup point according to the selection by the latter boarding member.

Patent Document 2 discloses an autonomous vehicle management system for sharing plural autonomous vehicles. In this system, plural porches to board and alight from any of the autonomous vehicles are set in advance, and travel information of the autonomous vehicles is determined based on desired reservation information including the user's desired boarding time, the porch for boarding the vehicle, and the porch for alighting from the vehicle. In this system, an estimated alighting time is updated and reservation confirmation information is changed in a case where it is impossible to arrive at the porch for alighting from the vehicle by the estimated alighting time included in the reservation confirmation information.

### PRIOR ART DOCUMENT(S)

### Patent Document(s)

Patent Document 1: JP2003-006294A

Patent Document 2: JP2016-057946A

### SUMMARY OF THE INVENTION

### Task to be Accomplished by the Invention

However, in such conventional vehicle ride-sharing assist systems, the driver of the ride-sharing vehicle may not be able to identify the user to pick up in a case where the driver cannot distinguish the user, especially, in a case where many people are present around the user.

In view of such a background, an object of the present invention is to provide a vehicle ride-sharing assist system that enables a driver of a ride-sharing vehicle to reliably identify a user at a pickup point and thus improves the convenience of ride-sharing.

### Means for Accomplishing the Task

To achieve such an object, one embodiment of the present invention provides a vehicle ride-sharing assist system (1) for assisting in identification of a user to board a ride-sharing vehicle (10) at a pickup point. The vehicle ride-sharing assist system includes a wirelessly communicable user terminal (2) configured to be carried by the user; a wirelessly communicable vehicle terminal (3) mounted on the ride-sharing vehicle; and a server (5) wirelessly communicable with the user terminal and the vehicle terminal and including a database, wherein the server further includes a proximity notification unit (36) configured to generate a proximity notification signal so as to transmit the proximity notification signal to the user terminal and the vehicle terminal when a distance between the user and the ride-sharing vehicle becomes equal to or less than a prescribed value, the vehicle terminal includes a user response request unit (28) configured to generate a user response request signal so as to transmit the user response request signal to the user terminal when the vehicle terminal receives the proximity notification signal, the user response request signal requesting a specific motion of the user or a specific operation of the user terminal, the user terminal includes a user side notification unit (22) configured to notify the user of the specific motion thereof according to the user response request signal transmitted from the vehicle terminal or a user side operation unit (22) configured to cause the user terminal to perform the specific operation thereof according to the user response request signal transmitted from the vehicle terminal, and the vehicle terminal further includes a user position identification unit (29) configured to detect the specific motion of the user or the specific operation of the user terminal and identify a position of the user based on the specific motion of the user or the specific operation of the user terminal and a user position notification unit (30) configured to notify the identified position of the user to a driver of the ride-sharing vehicle.

According to this arrangement, the user position identification unit identifies the position of the user based on a response from the user terminal or the user and the user position notification unit notifies the position of the user to the driver of the ride-sharing vehicle, so that the driver of the ride-sharing vehicle can identify the user. Accordingly, even in a case where a person is present around the user, the user can easily board the ride-sharing vehicle. Also, when the ride-sharing vehicle is in the proximity of the user, the user response request unit makes a request to the user terminal for a response, so that the response of the user terminal or the user can be easily detected by the user position identification unit.

In the above arrangement, preferably, the vehicle terminal (3) further includes a vehicle side information acquiring unit (14, 15) including an image capturing device (14) or a recording device (15), and the user position identification unit (29) is configured to detect the specific motion of the user or the specific operation of the user terminal (2) based on information acquired by the vehicle side information acquiring unit.

According to this arrangement, the vehicle terminal with a simple configuration including the vehicle side information acquiring unit can detect the response from the user or the user terminal by using the user position identification unit.

In the above arrangement, preferably, the vehicle ride-sharing assist system further includes an image database (7) configured to store positional information and surrounding image information related to the positional information or a sound database (8) configured to store the positional information and environmental sound information related to the positional information, wherein the user terminal (2) further includes a user side information acquiring unit (14, 15) including an image capturing device (14) or a recording device (15), the server (5) further includes a vehicle position estimation unit (34) configured to estimate a position of the ride-sharing vehicle (10) by referring to the image database or the sound database based on the information acquired by the vehicle side information acquiring unit (14, 15) and a user position estimation unit (33) configured to estimate the position of the user by referring to the image database or the sound database based on information acquired by the user side information acquiring unit (14, 15), and the proximity notification unit (36) is configured to generate the proximity notification signal when the distance between the user and the ride-sharing vehicle based on respective estimation results of the user position estimation unit and the vehicle position estimation unit becomes equal to or less than the prescribed value.

According to this arrangement, the server can estimate the positions of the ride-sharing vehicle and the user based on the information acquired by the vehicle side information acquiring unit and the user side information acquiring unit, and can generate the proximity notification signal.

In the above arrangement, preferably, the user terminal (2) further includes a GPS unit (12) as a position estimation unit of the user corresponding to the user terminal and the vehicle terminal (3) further includes a GPS unit (12) as a position estimation unit of the ride-sharing vehicle (10) corresponding to the vehicle terminal, and the proximity notification unit (36) is configured to generate the proximity notification signal when the distance between the user and the ride-sharing vehicle calculated based on the respective GPS units of the user terminal and the vehicle terminal becomes equal to or less than the prescribed value.

According to this arrangement, the server can easily understand the distance between the user and the ride-sharing vehicle without executing image processing, sound processing, or the like.

In the above arrangement, preferably, the vehicle terminal (3) further includes an operation unit (21) configured to cause the driver to designate the specific motion of the user or the specific operation of the user terminal (2) according to a notification from the proximity notification unit (36), and the user response request unit (28) is configured to generate the user response request signal requesting the specific motion of the user or the specific operation of the user terminal designated by the driver via the operation unit.

According to this arrangement, the driver can select the motion to request the user to make or the operation to request the user terminal to execute according to the situation or the like. Accordingly, the response from the user or the user terminal can be easily detected by the user position identification unit.

In the above arrangement, preferably, the specific motion of the user or the specific operation of the user terminal (2) includes sound generation by the user terminal or the motion of the user.

According to this arrangement, the position of the user can be smoothly identified by the motion or the operation that can be distinguished from the surroundings.

In the above arrangement, preferably, the specific motion of the user or the specific operation of the user terminal (2) includes transmission of an image of the user captured by the user side information acquiring unit (14) of the user terminal or transmission of a voice of the user recorded by the user side information acquiring unit (15) of the user terminal.

According to this arrangement, the user can be easily identified by using the information acquired by the user terminal.

In the above arrangement, preferably, the user terminal (2) further includes a vehicle response request unit (18) configured to generate a vehicle response request signal so as to transmit the vehicle response request signal to the vehicle terminal (3) when the user terminal receives the proximity notification signal, the vehicle response request signal requesting a specific operation of the ride-sharing vehicle (10), the vehicle terminal further includes a vehicle side notification unit (23) configured to notify the specific operation of the ride-sharing vehicle to the driver according to the vehicle response request signal transmitted from the user terminal or a vehicle side operation unit (23) configured to cause the ride-sharing vehicle to perform the specific operation thereof, and the user terminal further includes a vehicle position identification unit (19) configured to detect the specific operation of the ride-sharing vehicle and identify the position of the ride-sharing vehicle based on the specific operation of the ride-sharing vehicle and a vehicle position notification unit (20) configured to notify the identified position of the ride-sharing vehicle to the user.

According to this arrangement, the user can identify the ride-sharing vehicle. Accordingly, even if another vehicle is present around the ride-sharing vehicle, the user can easily board the ride-sharing vehicle. Also, when the ride-sharing vehicle is in the proximity of the user, the vehicle response request unit makes a request to the vehicle terminal for a response from the ride-sharing vehicle, so that the response from the ride-sharing vehicle can be easily detected by the vehicle position identification unit.

In the above arrangement, preferably, the vehicle position identification unit (19) is configured to detect the specific operation of the ride-sharing vehicle (10) based on the information acquired by the user side information acquiring unit (14, 15).

According to this arrangement, the user terminal with a simple configuration including the user side information acquiring unit can detect the response from the ride-sharing vehicle by using the vehicle position identification unit.

In the above arrangement, preferably, the server (5) further includes a ride-sharing information management unit (32) configured to set the position estimated by the user position estimation unit (33, 12) as the pickup point.

According to this arrangement, the ride-sharing information management unit sets the point where the user is (a point where the user captures the image, a point where the user makes a recording, or a point where the GPS information is acquired) as the pickup point. Accordingly, the user can easily set the point where he/she desires to board the ride-sharing vehicle as the pickup point.

In the above arrangement, preferably, the vehicle terminal (3) further includes a speaker (17), and the user position notification unit (30) is configured to notify the driver of proximity of the user by a notification sound from the speaker of the vehicle terminal when a distance between the ride-sharing vehicle (10) and the user or between the ride-sharing vehicle and the pickup point becomes equal to or less than the prescribed value.

According to this arrangement, the driver of the ride-sharing vehicle can auditorily recognize that the pickup point of the user is in the proximity thereof.

In the above arrangement, preferably, the user position notification unit (30) is configured to change volume or a tempo of the notification sound according to the distance between the ride-sharing vehicle (10) and the user or between the ride-sharing vehicle and the pickup point.

According to this arrangement, the driver of the ride-sharing vehicle can intuitively recognize that the pickup point of the user is in the proximity thereof

In the above arrangement, preferably, the user terminal (2) further includes a speaker (17), and the vehicle position notification unit (20) is configured to notify the user of proximity of the ride-sharing vehicle (10) by a notification sound from the speaker of the user terminal when a distance between the user and the ride-sharing vehicle or between the user and the pickup point becomes equal to or less than the prescribed value.

According to this arrangement, the user can auditorily recognize that the ride-sharing vehicle or the pickup point is in the proximity thereof.

In the above arrangement, preferably, the vehicle position notification unit (20) is configured to change volume or a tempo of the notification sound according to the distance between the user and the ride-sharing vehicle (10) or between the user and the pickup point.

According to this arrangement, the user can intuitively recognize that the ride-sharing vehicle or the pickup point is in the proximity thereof.

In the above arrangement, preferably, the vehicle terminal (3) further includes a display (16), and the user position notification unit (30) is configured to notify the position of the user to the driver by a map displayed on the display of the vehicle terminal when a distance between the ride-sharing vehicle (10) and the user or between the ride-sharing vehicle and the pickup point becomes equal to or less than the prescribed value.

According to this arrangement, the driver of the ride-sharing vehicle can recognize the relative position of the user or the pickup point with respect to the ride-sharing vehicle by the map on the display.

In the above arrangement, preferably, wherein the user terminal (2) further includes a display (16), and the vehicle position notification unit (20) is configured to notify the position of the ride-sharing vehicle (10) to the user by a map displayed on the display of the user terminal when a distance between the user and the ride-sharing vehicle or between the user and the pickup point becomes equal to or less than the prescribed value.

According to this arrangement, the user can recognize the relative position of the ride-sharing vehicle or the pickup point with respect to the user himself/herself by the map on the display.

In the above arrangement, preferably, the user position notification unit (30) is configured to create a route to the user or the pickup point and notify the position of the user to the driver by displaying the created route on the display of the vehicle terminal (3), the route being created based on the position of the ride-sharing vehicle (10) estimated by the vehicle position estimation unit (34, 12) and the position of the user estimated by the user position estimation unit (33, 12) or based on the position of the ride-sharing vehicle estimated by the vehicle position estimation unit and the pickup point.

According to this arrangement, the driver of the ride-sharing vehicle can arrive at the pickup point smoothly.

In the above arrangement, preferably, the vehicle terminal (3) is composed of the user terminal (2) carried by the driver.

According to this arrangement, the vehicle ride-sharing assist system can be used even if the ride-sharing vehicle is not provided with a camera or a recorder.

### Effect of the Invention

According to the above arrangements, it is possible to provide a vehicle ride-sharing assist system that enables a driver of a ride-sharing vehicle to reliably identify a user at a pickup point and thus improves the convenience of ride-sharing.

### BRIEF DESCRIPTION OF THE DRAWING(S)

FIG. 1 is a block diagram of a vehicle ride-sharing assist system according to an embodiment;

FIG. 2 is a sequence diagram showing outlines of processes executed by respective elements of the vehicle ride-sharing assist system;

FIG. 3 is a flow chart showing steps of a designating process of a pickup point shown in FIG. 2;

FIG. 4 is a flow chart showing steps of a setting process of the pickup point shown in FIG. 2;

FIG. 5 is a flow chart showing steps of a proximity detection and notification process shown in FIG. 2;

FIG. 6 is a flow chart showing steps of a request process of a user response shown in FIG. 2;

FIG. 7 is a flow chart showing steps of an execution process of a requested vehicle response shown in FIG. 2;

FIG. 8 is a flow chart showing steps of a detection and notification process of the requested user response shown in FIG. 2;

FIG. 9 is a flow chart showing steps of a request process of the vehicle response shown in FIG. 2;

FIG. 10 is a flow chart showing steps of an execution process of the requested user response shown in FIG. 2; and

FIG. 11 is a flow chart showing steps of a detection and notification process of the requested vehicle response shown in FIG. 2.

### MODES FOR CARRYING OUT THE INVENTION

In the following, an embodiment of the present invention will be described in detail with reference to the drawings.

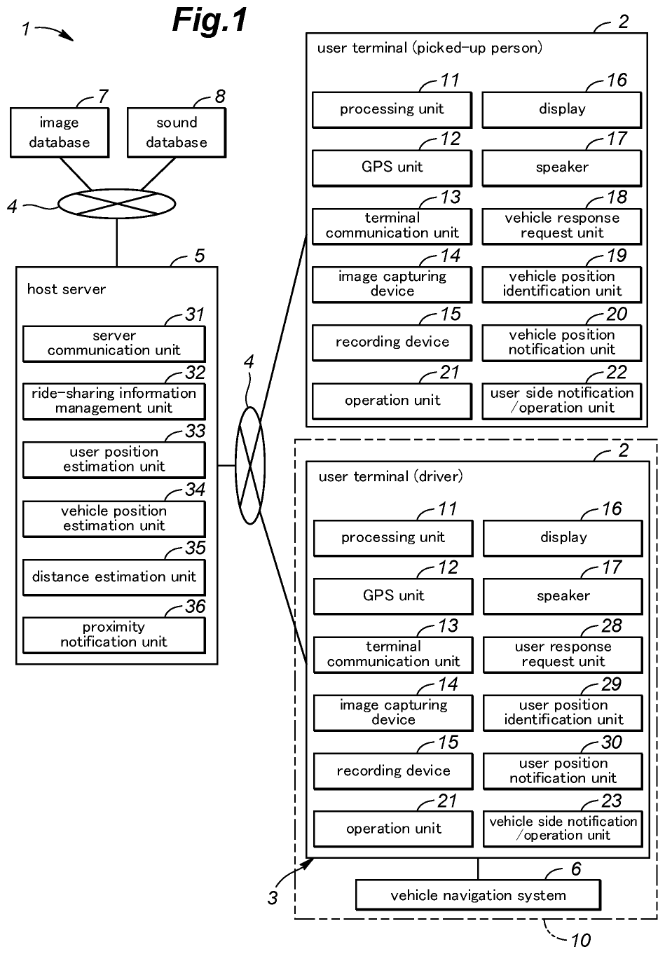

FIG. 1 is a block diagram of a vehicle ride-sharing assist system 1 according to the embodiment. The vehicle ride-sharing assist system 1 according to the embodiment provides services to the members (users) of a specific group (a company, a government office, a sports club, a nursing home, a shopping center, or the like). Especially, the vehicle ride-sharing assist system 1 provides ride-sharing services of automobiles when the specific group commute in the morning or evening and move to a facility.

The group that uses the vehicle ride-sharing assist system 1 according to the embodiment owns plural shared vehicles in order to cause the members thereof to use the shared vehicles. For the ride-sharing, the vehicle ride-sharing assist system 1 uses the plural shared vehicles and the members' private vehicles which the members have agreed to use for the ride-sharing (hereinafter referred to as “provided vehicles”) as ride-sharing vehicles 10. All of the users, the shared vehicles, and the provided vehicles are registered in the vehicle ride-sharing assist system 1. In the vehicle ride-sharing assist system 1, user identification numbers are set for all of the users, and vehicle identification numbers are set for all of the shared vehicles and the provided vehicles.

As shown in FIG. 1, the vehicle ride-sharing assist system 1 includes plural wirelessly communicable user terminals 2 (one of the user terminals 2 is shown in FIG. 1), a wirelessly communicable vehicle terminal 3 mounted on the ride-sharing vehicle 10, and a host server 5 connected to each user terminal 2 and the vehicle terminal 3 via a network 4. Each user terminal 2 is configured to be carried by each user. The vehicle terminal 3 is composed of the user terminal 2 carried by the driver of the ride-sharing vehicle 10 and a vehicle navigation system 6 provided in the ride-sharing vehicle 10. The host server 5 is provided inside the building of the company that manages the vehicle ride-sharing assist system 1, and is connected to an image database 7 and a sound database 8 the network 4. The network 4 is, for example, the Internet.

The image database 7 is configured to store positional information and surrounding image information related to the positional information. The surrounding image information includes information about an image (static image) captured at a present position and information about video (moving image) captured at the present position. The surrounding image information may include only one of the information about the image and the information about the video.

The sound database 8 is configured to store positional information and environmental sound information related to the positional information. The environmental sound information is information about an environmental sound recorded at the present position.

The user terminal 2 includes a processing unit 11, a Global Positioning System unit 12 (GPS unit), a terminal communication unit 13, an image capturing device 14, a recording device 15, a display 16, a speaker 17, and the like. The processing unit 11 is configured to execute an application. The GPS unit 12 is a position estimation unit configured to receive radio waves from satellites so as to measure a position of the user terminal 2. The terminal communication unit 13 is configured to communicate with the host server 5 and the vehicle terminal 3 via the network 4. The image capturing device 14 is configured to capture an image or video. The display 16 is configured to display an input screen and a message. The speaker 17 is configured to generate a notification sound and a guidance voice. Further, the user terminal 2 includes an operation unit 21 as a user interface configured to receive an input operation by a user. The user terminal 2 is, for example, a smartphone, a tablet PC, a mobile phone, a PDA, or the like. The display 16 having a touch panel function may also be used as the operation unit 21. The user terminal 2 is configured to operate as the processing unit 11 executes the application.

In a case where the user as the driver is driving the ride-sharing vehicle 10, the user terminal 2 of this user (hereinafter simply referred to as “driver”) functions as the vehicle terminal 3, and the user terminal 2 of the user to board a traveling ride-sharing vehicle 10 functions as a terminal for the user.

The host server 5 includes a server communication unit 31, a ride-sharing information management unit 32, a user position estimation unit 33, a vehicle position estimation unit 34, and the like. The server communication unit 31 is configured to communicate with the user terminal 2 via the network 4. The ride-sharing information management unit 32 is configured to receive ride-sharing applications from the users and group the users who have performed the ride-sharing applications so as to create a ride-sharing group. The ride-sharing information management unit 32 is configured to use built-in navigation data or an external navigation server, create an operation schedule of the ride-sharing vehicle 10 which the ride-sharing group ride, and manage the operation schedule. The user position estimation unit 33 is configured to estimate the position of the user registered in the ride-sharing group. The vehicle position estimation unit 34 is configured to estimate the position of the ride-sharing vehicle 10. In addition, the host server 5 includes a distance estimation unit 35 and a proximity notification unit 36. The distance estimation unit 35 is configured to estimate a distance between the user and the ride-sharing vehicle 10 based on the position of the user estimated by the user position estimation unit 33 and the position of the ride-sharing vehicle 10 estimated by the vehicle position estimation unit 34. The proximity notification unit 36 is configured to notify the proximity of the user and the ride-sharing vehicle 10 when the distance between the user and the ride-sharing vehicle 10 becomes equal to or less than a prescribed value.

The ride-sharing information management unit 32 is configured to set a point where each user should board the ride-sharing vehicle 10 as a pickup point in creating the operation schedule of the ride-sharing vehicle 10. At this time, the ride-sharing information management unit 32 is configured to present the options of designating methods for designating the pickup point, receive the pickup point designated as the desired place according to the designating method selected by the user, and thus set the pickup point.

Specifically, the ride-sharing information management unit 32 is configured to present the following options (1)-(9) and the like as the designating methods of the pickup point.

(1) selection of points based on a map
(2) a landmark list proposed by the ride-sharing information management unit 32
(3) a list of points registered by the user in advance
(4) a positional information from the GPS unit 12 of the user terminal 2
(5) an image of the surroundings
(6) video of the surroundings
(7) an environmental sound of the surroundings
(8) an automatic proposal based on past selection
(9) the best pickup point proposed by the ride-sharing information management unit 32 according to the season and the time

The user can select at least one pickup point and a priority order of the desired pickup point by at least one designating method selected from the presented options.

The ride-sharing information management unit 32 is configured to identify the pickup point by a point identification method selected from the following options (1)-(8) or the like after accepting the pickup point designated by the designating method selected by the user.

(1) conversion from points on the map to latitude and longitude information
(2) acquisition of the latitude and longitude information from the landmark list
(3) acquisition of the latitude and longitude information from the list registered in advance
(4) acquisition of the positional information (latitude and longitude information) from the GPS unit 12 of the user terminal 2
(5) conversion from the surrounding image information to the latitude and longitude information by environmental image matching
(6) conversion from the surrounding video information to the latitude and longitude information by moving image matching
(7) conversion from the environmental sound of the surroundings to the latitude and longitude information by environmental sound matching
(8) acquisition of the latitude and longitude information from past user data

Also, during the operation of the ride-sharing vehicle 10, the ride-sharing information management unit 32 is configured to set the position of the user estimated by the user position estimation unit 33 or the position of the user acquired from the GPS unit 12 of the user terminal 2 as the pickup point. Namely, the ride-sharing information management unit 32 is configured to change the pickup point from a scheduled place to a place where the user is.

The user position estimation unit 33 is configured to refer to the image database 7 or the sound database 8 based on the information acquired by the image capturing device 14 or the recording device 15 (user side information acquiring unit) of the user terminal 2 and thus estimate the position of the user. Further, the user position estimation unit 33 is configured to acquire the position acquired by the GPS unit 12 (position estimation unit) of the user terminal 2 and thus set this position as the estimated position of the user. The user position estimation unit 33 may estimate the position of the user by referring to both the image database 7 and the sound database 8, or by referring to either one of the image database 7 and the sound database 8. Further, the user position estimation unit 33 may estimate the position of the user by referring to the image database 7 or the sound database 8 and/or by using the positional information from the GPS unit 12 of the user terminal 2.

The vehicle position estimation unit 34 is configured to refer to the image database 7 or the sound database 8 based on the information acquired by the image capturing device 14 or the recording device 15 (vehicle side information acquiring unit) of the vehicle terminal 3 and thus estimate the position of the ride-sharing vehicle 10. Further, the vehicle position estimation unit 34 is configured to acquire the position acquired by the GPS unit 12 (position estimation unit) of the vehicle terminal 3 and thus set this position as the estimated position of the ride-sharing vehicle 10. The vehicle position estimation unit 34 may estimate the position of the ride-sharing vehicle 10 by referring to both the image database 7 and the sound database 8, or by referring to either one of the image database 7 and the sound database 8. Further, the vehicle position estimation unit 34 may estimate the position of the ride-sharing vehicle 10 by referring to the image database 7 or the sound database 8 and/or by using the positional information from the GPS unit 12 of the vehicle terminal 3.

The distance estimation unit 35 is configured to set a linear distance between the position of the user estimated by the user position estimation unit 33 and the position of the ride-sharing vehicle 10 estimated by the vehicle position estimation unit 34 as the estimated distance between the user and the ride-sharing vehicle 10.

The proximity notification unit 36 is configured to generate a proximity notification signal, which indicates the proximity of the user and the ride-sharing vehicle 10 and the distance between the two, and thus transmit the proximity notification signal to the user terminal 2 and the vehicle terminal 3 via the server communication unit 31, when the distance between the user and the ride-sharing vehicle 10 calculated by the distance estimation unit 35 becomes equal to or less than the prescribed value. The proximity notification unit 36 is configured to keep on generating the proximity notification signal while the distance between the user and the ride-sharing vehicle 10 is equal to or less than the prescribed value.

The user terminal 2, which functions as a terminal for the user, further includes a vehicle response request unit 18, a vehicle position identification unit 19, a vehicle position notification unit 20, and a user side notification/operation unit 22. The vehicle response request unit 18 is configured to make a request to the vehicle terminal 3 for a prescribed response (operation) that enables the ride-sharing vehicle 10 to be identified. The vehicle position identification unit 19 is configured to detect the requested response from the ride-sharing vehicle 10 and thus identify the position of the ride-sharing vehicle 10. The vehicle position notification unit 20 is configured to notify the user of the position of the ride-sharing vehicle 10 identified by the vehicle position identification unit 19.

The vehicle response request unit 18 is configured to generate a vehicle response request signal to the vehicle terminal 3 so as to transmit the vehicle response request signal to the vehicle terminal 3 when the user terminal 2 receives the proximity notification signal, namely, when the distance between the user and the ride-sharing vehicle 10 becomes equal to or less than the prescribed value. The prescribed response that enables the ride-sharing vehicle 10 to be identified is, for example, the following (1)-(5) or the like.

(1) blink of hazard lights of the ride-sharing vehicle 10
(2) blink of headlights (flashing) of the ride-sharing vehicle 10
(3) transmission of an image of the sky, a high-rise building, or the like viewed from the ride-sharing vehicle 10
(4) transmission of video viewed from the ride-sharing vehicle 10
(5) transmission of a vehicle position map in the vehicle navigation system 6

These responses may be made by the vehicle terminal 3 (the undermentioned vehicle side notification/operation unit 23) that has received the request. Alternatively, these responses may be made as the driver operates the ride-sharing vehicle 10 according to the request notified by the vehicle terminal 3 (the undermentioned vehicle side notification/operation unit 23) that has received the request.

The vehicle position identification unit 19 is configured to detect the above prescribed response that enables the ride-sharing vehicle 10 to be identified based on the information about the image (video) acquired by the image capturing device 14 of the user terminal 2 or the recording information acquired by the recording device 15 of the user terminal 2. Namely, the vehicle position identification unit 19 is configured to analyze whether the above response is included in the image information or the recording information. When the vehicle position identification unit 19 detects the above response, the vehicle position identification unit 19 identifies the vehicle that has made the response as the ride-sharing vehicle 10.

The vehicle position notification unit 20 is configured to notify the user of the position of the ride-sharing vehicle 10, which is identified by the vehicle position identification unit 19, via the display 16 or the speaker 17, in a case where the vehicle position identification unit 19 identifies the position of the ride-sharing vehicle 10. For example, the vehicle position notification unit 20 is configured to notify the user of the proximity of the ride-sharing vehicle 10 by a notification sound from the speaker 17 of the user terminal 2 when the distance between the user and the ride-sharing vehicle 10 or between the user and the pickup point becomes equal to or less than the prescribed value. At this time, the vehicle position notification unit 20 is configured to change volume or a tempo of the notification sound according to the distance between the user and the ride-sharing vehicle 10 or between the user and the pickup point.

The user terminal 2 which functions as the vehicle terminal 3 further includes a user response request unit 28, a user position identification unit 29, a user position notification unit 30, and a vehicle side notification/operation unit 23. The user response request unit 28 is configured to make a request to the user terminal 2 (specifically, the user terminal 2 of the user to board a traveling ride-sharing vehicle 10) for a prescribed response (motion or operation) that enables the user to be identified. The user position identification unit 29 is configured to detect the requested operation of the user terminal 2 or the requested motion of the user, and thus identify the position of the user. The user position notification unit 30 is configured to notify the driver of the position of the user identified by the user position identification unit 29. The vehicle side notification/operation unit 23 is configured to notify the driver of the requested motion according to the vehicle response request signal transmitted from the user terminal 2, or cause the ride-sharing vehicle 10 to execute the requested operation.

The user response request unit 28 is configured to generate a user response request signal to the user terminal 2 so as to transmit the user response request signal to the user terminal 2, when the vehicle terminal 3 receives the proximity notification signal, namely, when the distance between the user and the ride-sharing vehicle 10 becomes equal to or less than the prescribed value. The prescribed response that enables the user to be identified is, for example, the following (1)-(4) or the like.

(1) sound generation by the user terminal 2
(2) a motion of the user such as a wave of the user's hand
(3) transmission of a user's image captured by the image capturing device 14 of the user terminal 2 according to the user's operation
(4) transmission of a user's voice recorded by the recording device 15 of the user terminal 2 according to the user's operation

The sound generation (operation) by the user terminal 2 in the above (1) is executed as the user side notification/operation unit 22 drives the speaker 17. The motion of the user in the above (2) is made by the user whom the user side notification/operation unit 22 notifies of the request. The operations of the user terminal 2 in the above (3) and (4) are executed as the user operates the user terminal 2 according to the request notified by the user side notification/operation unit 22.

The user position identification unit 29 is configured to detect the above prescribed response that enables the user to be identified based on the information about the image (video) acquired by the image capturing device 14 of the vehicle terminal 3 or the recording information acquired by the recording device 15. Namely, the user position identification unit 29 is configured to analyze whether the response is included in the image information or the recording information. When the user position identification unit 29 detects the above response, the user position identification unit 29 identifies the owner of the user terminal 2 which has executed the operation as the user, or identifies the person who has made the detected motion as the user.

The user position notification unit 30 is configured to notify the driver of the position of the user, which is identified by the user position identification unit 29, via the display 16 or the speaker 17, in a case where the user position identification unit 29 identifies the position of the user. For example, the user position notification unit 30 is configured to notify the driver of the proximity of the user by a notification sound from the speaker 17 of the vehicle terminal 3 when the distance between the ride-sharing vehicle 10 and the user or between the ride-sharing vehicle 10 and the pickup point becomes equal to or less than the prescribed value. At this time, the user position notification unit 30 is configured to change volume or a tempo of the notification sound according to the distance between the ride-sharing vehicle 10 and the user or between the ride-sharing vehicle 10 and the pickup point.

Alternatively, the user position notification unit 30 is configured to notify the driver of the position of the user by a map displayed on the display 16 of the vehicle terminal 3 when the distance between the ride-sharing vehicle 10 and the user or between the ride-sharing vehicle 10 and the pickup point becomes equal to or less than the prescribed value. Further, the user position notification unit 30 is configured to create a route to the user or the pickup point and notify the driver of the position of the user by displaying the created route on the display 16 of the vehicle terminal 3. The route is created based on the position of the ride-sharing vehicle 10 estimated by the vehicle position estimation unit 34 or the GPS unit 12 of the vehicle terminal 3 and the position of the user estimated by the user position estimation unit 33 or the GPS unit 12 of the user terminal 2. Alternatively, the route is created based on the position of the ride-sharing vehicle 10 estimated by the vehicle position estimation unit 34 or the GPS unit 12 of the vehicle terminal 3 and the pickup point.

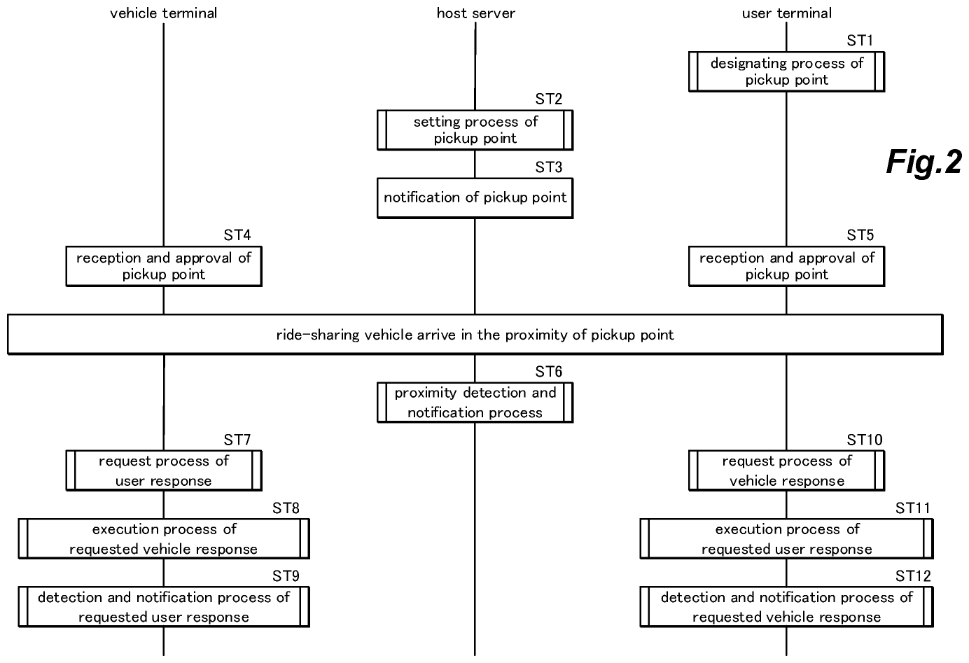

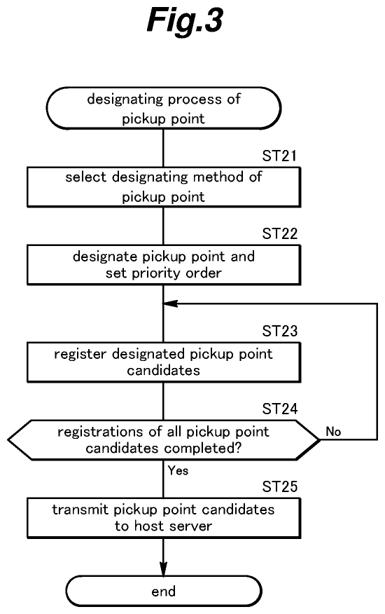

FIG. 2 is a sequence diagram showing outlines of processes executed by the respective elements of the vehicle ride-sharing assist system 1. As shown in FIG. 2, in the vehicle ride-sharing assist system 1, the respective elements (the user terminal 2, the vehicle terminal 3, and the host server 5) execute the processes according to the following steps. First, the outline of the processes will be described with reference to FIG. 2. Next, the details of each process will be described with reference to FIGS. 3 to 11.

First, the user terminal 2 executes a designating process of the pickup point of each user (step ST1). Next, the host server 5 executes a setting process of the pickup point in the operation schedule (step ST2), and notifies the user terminal 2 and the vehicle terminal 3 of the pickup point (step ST3). When the vehicle terminal 3 receives the notification of the pickup point, the vehicle terminal 3 executes an approval process by the user to be the driver of the ride-sharing vehicle 10 (step ST4). On the other hand, when the user terminal 2 receives the notification of the pickup point, the user terminal 2 executes an approval process by the user (step ST5).

After the ride-sharing vehicle 10 arrives in the proximity of the pickup point of the user, the host server 5 executes a proximity detection and notification process (step ST6). After that, the vehicle terminal 3 executes a request process of the user response (step ST7), an execution process of the requested vehicle response (step ST8), and a detection and notification process of the requested user response (step ST9). The process of step ST8 may be executed simultaneously with the process of step ST7 or the process of step ST9, or may be executed before or after these processes. After the proximity detection and notification process (step ST6) by the host server 5, the user terminal 2 executes a request process of the vehicle response (step ST10), an execution process of the requested user response (step ST11), and a detection and notification process of the requested vehicle response (step ST12). The process of step ST11 may be performed simultaneously with the process of step ST10 or the process of step ST12, or may be performed before or after these processes.

FIG. 3 is a flow chart showing steps of the designating process of the pickup point in step ST1 of FIG. 2. In the designating process of the pickup point, the user terminal 2 selects the designating method of the pickup point according to the user's operation (step ST21). Then, the user terminal 2 designates the pickup point desired by the user (selected by the user's operation) according to the selected designating method, and thus sets the priority order of each designated pickup point (step ST22). Then, the user terminal 2 registers the designated pickup point candidates (step ST23). If the registrations of all the pickup point candidates are not completed (step ST24: No), the user terminal 2 repeats the process of step ST23. When the registrations of all the pickup point candidates are completed (step ST24: Yes), the user terminal 2 transmits the pickup point candidates to the host server 5 (step ST25), and ends this process.

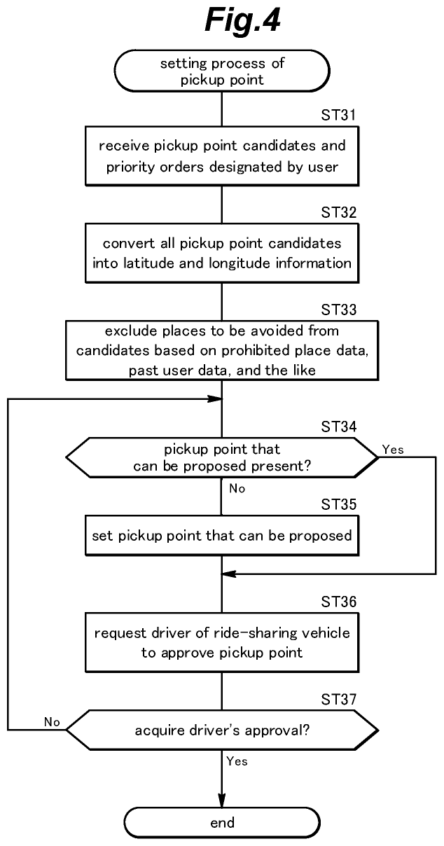

FIG. 4 is a flow chart showing steps of the setting process of the pickup point in step ST2 of FIG. 2. In this process, the host server 5 (ride-sharing information management unit 32) receives the pickup point candidates and their priority orders designated by the user (step ST31) and converts all the received pickup point candidates into latitude and longitude information by any of the above point designating methods (step ST32). Next, the host server 5 excludes places to be avoided from the candidates based on prohibited place data, past user data, and the like (step ST33), and determines whether a pickup point that can be proposed is present (step ST34). In a case where the pickup point that can be proposed is not present (step ST34: No), the host server 5 sets the pickup point that can be proposed (step ST35). In a case where the pickup point that can be proposed is present (step ST34: Yes), or after the process of step ST35, the host server 5 requests the driver of the ride-sharing vehicle 10 to approve the pickup point (step ST36). In a case where the host server 5 cannot acquire the driver's approval (step ST37: No), the host server 5 repeats the processes from step ST34 onward. In a case where the host server 5 can acquire the driver's approval (step ST37: Yes), the host server 5 ends this process.

As described above, the position of the user estimated by the user position estimation unit 33 or the GPS unit 12 of the user terminal 2 can be set as the pickup point by the ride-sharing information management unit 32 of the host server 5. Namely, the point where the user is (a point where the user captures the image, a point where the user makes a recording, or a point where the GPS information is acquired) can be set as the pickup point. Accordingly, the user can easily set the point where he/she desires to board the ride-sharing vehicle 10 as the pickup point.

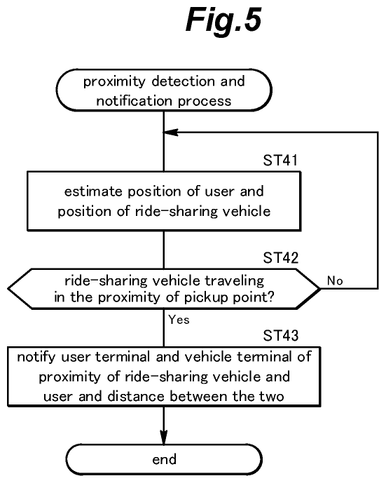

FIG. 5 is a flow chart showing steps of the proximity detection and notification process in step ST6 of FIG. 2. In this process, the user position estimation unit 33 of the host server 5 estimates the position of the user by referring to the image database 7 or the sound database 8 based on the information acquired by the image capturing device 14 or the recording device 15 (user side information acquiring unit) of the user terminal 2. Further, the vehicle position estimation unit 34 of the host server 5 estimates the position of the ride-sharing vehicle 10 by referring to the image database 7 or the sound database 8 based on the information acquired by the image capturing device 14 or the recording device 15 (vehicle side information acquiring unit) of the vehicle terminal 3 (step ST41).

Next, the distance estimation unit 35 of the host server 5 determines whether the ride-sharing vehicle 10 is traveling in the proximity of the user, that is, in the proximity of the pickup point (step ST42). In a case where the ride-sharing vehicle 10 is not traveling in the proximity of the pickup point (step ST42: No), the host server 5 repeats the processes from step ST41 onward. In a case where it is determined that the ride-sharing vehicle 10 is traveling in the proximity of the pickup point (step ST42: Yes), the proximity notification unit 36 of the host server 5 generates the proximity notification signal and transmits the generated proximity notification signal to the user terminal 2 of the user to board the ride-sharing vehicle 10 at the pickup point and the vehicle terminal 3, thereby notifying the user terminal 2 and the vehicle terminal 3 of the proximity of the ride-sharing vehicle 10 and the user and the distance between the two (step ST43). Then, the host server 5 ends this process. Incidentally, the notification in step ST43 does not end by executed once, and is repeated until the user is picked up by the ride-sharing vehicle 10.

As described above, the host server 5 refers to the image database 7 or the sound database 8 based on the information acquired by the vehicle side information acquiring unit and the user side information acquiring unit, so that the host server 5 can estimate the positions of the ride-sharing vehicle 10 and the user terminal 2 and generate the proximity notification signal.

As described above, in step ST41, the user position estimation unit 33 may acquire the position acquired by the GPS unit 12 of the user terminal 2 and set this position to the estimated position of the user. Further, the vehicle position estimation unit 34 may acquire the position acquired by the GPS unit 12 of the vehicle terminal 3 and set this position to the estimated position of the ride-sharing vehicle 10. Accordingly, the host server 5 can easily understand the distance between the user and the ride-sharing vehicle 10 without executing image processing, sound processing, or the like.

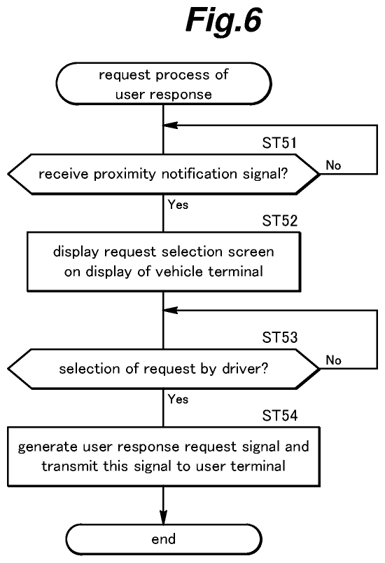

FIG. 6 is a flow chart showing steps of the request process of the user response in step ST7 of FIG. 2. In this process, the vehicle terminal 3 (user response request unit 28) determines whether the vehicle terminal 3 has received the proximity notification signal from the host server 5 (step ST51). In a case where the vehicle terminal 3 has not received the proximity notification signal (step ST51: No), the vehicle terminal 3 repeats this process. In a case where the vehicle terminal 3 has received the proximity notification signal (step ST51: Yes), the vehicle terminal 3 causes the display 16 of the vehicle terminal 3 to display the proximity of the user, the distance to the user, and a request selection screen showing options of the prescribed response that enables the user to be identified (step ST52).

Next, the vehicle terminal 3 determines whether the driver has made the selection of the request via the operation unit 21 (step ST53). In a case where the driver has not made the selection of the request (step ST53: No), the vehicle terminal 3 repeats this process. In a case where the driver has made the selection of the request (step ST53: Yes), the vehicle terminal 3 generates the user response request signal corresponding to the selected response (motion/operation), transmits the user response request signal to the user terminal 2 (step ST54), and ends this process.

As described above, when the distance between the user and the ride-sharing vehicle 10 becomes equal to or less than the prescribed value and thus the vehicle terminal 3 receives the proximity notification signal, the user response request unit 28 generates the user response request signal to the user terminal 2 so as to transmit the user response request signal to the user terminal 2. Accordingly, the operation of the user terminal 2 or the motion of the user can be easily detected by the user position identification unit 29.

Further, the vehicle terminal 3 includes the operation unit 21 for designating a specific response from the user or the user terminal 2, so that the driver can select the motion to request the user to make or the operation to request the user terminal 2 to execute according to the situation or the like. Accordingly, the response from the user or the user terminal can be easily detected by the user position identification unit 29.

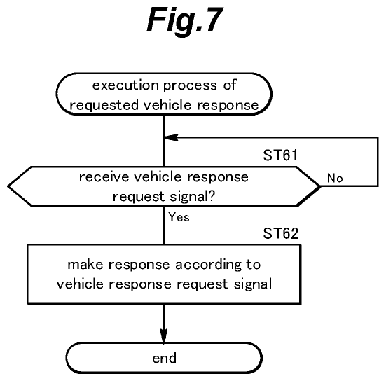

FIG. 7 is a flow chart showing steps of the execution process of the requested vehicle response in step ST8 of FIG. 2. In this process, the vehicle terminal 3 determines whether the vehicle terminal 3 has received the vehicle response request signal generated by the user terminal 2 (step ST61). In a case where the vehicle terminal 3 has not received the vehicle response request signal (step ST61: No), the vehicle terminal 3 repeats this process. In a case where the vehicle terminal 3 has received the vehicle response request signal (step ST61: Yes), the vehicle terminal 3 makes the response according to the vehicle response request signal (step ST62), and ends this process.

In step ST62, the vehicle terminal 3 directly controls the ride-sharing vehicle 10 to blink the hazard lights or the headlights, and thus the response is made. Alternatively, the reception of the vehicle response request signal and the content of the requested response are displayed on the display 16 or broadcast by the speaker 17 so as to prompt the driver to operate the ride-sharing vehicle 10, and thus the response is made.

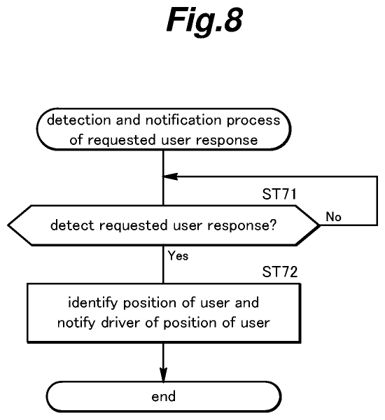

FIG. 8 is a flow chart showing steps of the detection and notification process of the requested user response in step ST9 of FIG. 2. In this process, the user position identification unit 29 of the vehicle terminal 3 determines whether the requested user response is detected in response to the transmission of the user response request signal to the user terminal 2 based on the information acquired by the image capturing device 14 or the recording device 15 of the vehicle terminal 3 (step ST71). In a case where the user response is not detected (step ST71: No), the vehicle terminal 3 repeats this process. In a case where the user response is detected (step ST71: Yes), the user position identification unit 29 of the vehicle terminal 3 identifies the position of the person whose motion is detected or the owner of the user terminal 2 whose operation is detected, namely, the position of the user. Also, the user position notification unit 30 of the vehicle terminal 3 notifies the driver of the position of the user (step ST72). Then, the vehicle terminal 3 ends this process.

In the process of step ST71, the user position identification unit 29 detects the specific motion of the user or the specific operation of the user terminal 2 based on information acquired by the image capturing device 14 or the recording device 15 (vehicle side information acquiring unit) of the vehicle terminal 3. Accordingly, the vehicle terminal 3 with a simple configuration including the vehicle side information acquiring unit can detect the response from the user or the user terminal by using the user position identification unit 29.

In the process of step ST72, the user position notification unit 30 notifies the driver of the ride-sharing vehicle 10 that the user is in the proximity thereof by a notification sound from the speaker 17 of the vehicle terminal 3. Accordingly, the driver of the ride-sharing vehicle 10 can auditorily recognize that the pickup point of the user is in the proximity thereof. Also, at this time, the user position notification unit 30 changes volume or a tempo of the notification sound according to the distance between the ride-sharing vehicle 10 and the user or between the ride-sharing vehicle 10 and the pickup point. Accordingly, the driver of the ride-sharing vehicle 10 can intuitively recognize that the pickup point of the user is in the proximity thereof.

Alternatively, in the process of step ST72, the user position notification unit 30 notifies the position of the user to the driver of the ride-sharing vehicle 10 by a map displayed on the display 16 of the vehicle terminal 3. Accordingly, the driver of the ride-sharing vehicle 10 can recognize the relative position of the user or the pickup point with respect to the ride-sharing vehicle 10 by the map on the display 16.

Alternatively, in the process of step ST72, the user position notification unit 30 creates a route to the user or the pickup point and notifies the position of the user to the driver of the ride-sharing vehicle 10 by displaying the created route on the display 16 of the vehicle terminal 3. The route is created based on the position of the ride-sharing vehicle 10 estimated by the vehicle position estimation unit 34 or the GPS unit 12 of the vehicle terminal 3 and the position of the user estimated by the user position estimation unit 33 or the GPS unit 12 of the user terminal 2. Alternatively, the route is created based on the position of the ride-sharing vehicle 10 estimated by the vehicle position estimation unit 34 or the GPS unit 12 of the vehicle terminal 3 and the pickup point. Accordingly, the driver of the ride-sharing vehicle 10 can arrive at the pickup point smoothly.

As described above, the vehicle terminal 3 includes the user position identification unit 29 and the user position notification unit 30. The user position identification unit 29 detects the specific motion of the user or the specific operation of the user terminal 2 and identifies the position of the user. The user position notification unit 30 notifies the identified position of the user to the driver of the ride-sharing vehicle 10. Accordingly, the driver of the ride-sharing vehicle 10 can identify the user, and the user can easily board the ride-sharing vehicle 10 even in a case where a person is present around the user.

As described above, the specific motion of the user or the specific operation of the user terminal 2 includes sound generation by the user terminal 2 or the motion of the user. Accordingly, the position of the user can be smoothly identified by the motion or the operation that can be distinguished from the surroundings.

Also, as described above, the specific motion of the user or the specific operation of the user terminal 2 includes transmission of an image of the user captured by the image capturing device 14 of the user terminal 2 or transmission of a voice of the user recorded by the recording device 15 of the user terminal 2. Accordingly, the user can be easily identified by using the information acquired by the user terminal 2.

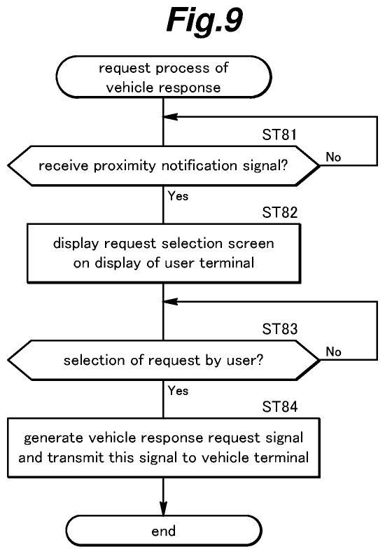

FIG. 9 is a flow chart showing steps of the request process of the vehicle response in step ST10 of FIG. 2. In this process, the user terminal 2 (vehicle response request unit 18) determines whether the user terminal 2 has received the proximity notification signal from the host server 5 (step ST81). In a case where the user terminal 2 has not received the proximity notification signal (step ST81: No), the user terminal 2 repeats this process. In a case where the user terminal 2 has received the proximity notification signal (step ST81: Yes), the user terminal 2 causes the display 16 of the user terminal 2 to display the proximity of the ride-sharing vehicle 10, the distance to the ride-sharing vehicle 10, and a request selection screen showing options of the prescribed response that enables the ride-sharing vehicle 10 to be identified (step ST82). Next, the user terminal 2 determines whether the user has made the selection of the request via the operation unit 21 (step ST83). In a case where the user has not made the selection of the request (step ST83: No), the user terminal 2 repeats this process. In a case where the user has made the selection of the request (step ST83: Yes), the user terminal 2 generates the vehicle response request signal corresponding to the selected response (motion/operation), transmits the vehicle response request signal to the vehicle terminal 3 (step ST84), and ends this process.

As described above, when the distance between the user and the ride-sharing vehicle 10 becomes equal to or less than the prescribed value and thus the user terminal 2 receives the proximity notification signal, the vehicle response request unit 18 generates the vehicle response request signal to the vehicle terminal 3 so as to transmit the vehicle response request signal to the vehicle terminal 3. Accordingly, the response from the ride-sharing vehicle 10 can be easily detected by the vehicle position identification unit 19.

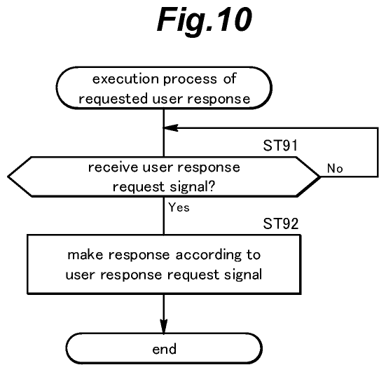

FIG. 10 is a flow chart showing steps of the execution process of the requested user response in step ST11 of FIG. 2. In this process, the user terminal 2 determines whether the user terminal 2 has received the user response request signal generated by the vehicle terminal 3 (step ST91). In a case where the user terminal 2 has not received the user response request signal (step ST91: No), the user terminal 2 repeats this process. In a case where the user terminal 2 has received the user response request signal (step ST91: Yes), the user terminal 2 makes the response according to the user response request signal (step ST92), and ends this process.

In step ST92, the user terminal 2 directly operates to generate a sound, and thus the response is made. Alternatively, the reception of the user response request signal and the content of the requested response are displayed on the display 16 or broadcast by the speaker 17 so as to prompt the user to make the motion, and thus the response is made.

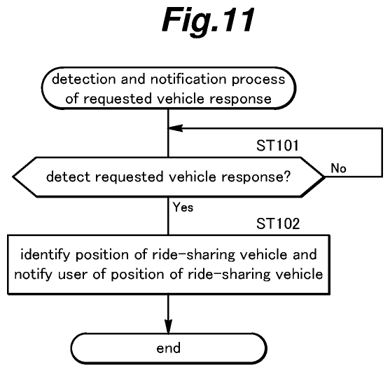

FIG. 11 is a flow chart showing steps of the detection and notification process of the requested vehicle response in step ST12 of FIG. 2. In this process, the vehicle position identification unit 19 of the user terminal 2 determines whether the requested vehicle response is detected in response to the transmission of the vehicle response request signal to the vehicle terminal 3 based on the information acquired by the image capturing device 14 or the recording device 15 of the user terminal 2 (step ST101). In a case where the vehicle response is not detected (step ST101: No), the user terminal 2 repeats this process. In a case where the vehicle response is detected (step ST101: Yes), the vehicle position identification unit 19 of the user terminal 2 identifies the position of the vehicle whose response is detected, namely, the position of the ride-sharing vehicle 10. Also, the vehicle position notification unit 20 of the user terminal 2 notifies the user of the position of the ride-sharing vehicle 10 (step ST102). Then, the user terminal 2 ends this process.

In the process of step ST101, the vehicle position identification unit 19 detects the specific operation of the ride-sharing vehicle 10 based on information acquired by the image capturing device 14 or the recording device 15 (user side information acquiring unit) of the user terminal 2. Accordingly, the user terminal 2 with a simple configuration including the user side information acquiring unit can detect the response from the ride-sharing vehicle 10 by using the vehicle position identification unit 19.

In the process of step ST102, the vehicle position notification unit 20 notifies the user that the ride-sharing vehicle 10 is in the proximity thereof by a notification sound from the speaker 17 of the user terminal 2. Accordingly, the user can auditorily recognize that the ride-sharing vehicle 10 or the pickup point is in the proximity thereof. Also, at this time, the vehicle position notification unit 20 changes volume or a tempo of the notification sound according to the distance between the user and the ride-sharing vehicle 10 or between the user and the pickup point. Accordingly, the user can intuitively recognize that the ride-sharing vehicle 10 or the pickup point is in the proximity thereof.

Alternatively, in the process of step ST102, the vehicle position notification unit 20 notifies the position of the ride-sharing vehicle 10 to the user by a map displayed on the display 16 of the user terminal 2. Accordingly, the user can recognize the relative position of the ride-sharing vehicle 10 or the pickup point with respect to the user himself/herself by the map on the display 16.

As described above, the user terminal 2 includes the vehicle position identification unit 19 and the vehicle position notification unit 20. The vehicle position identification unit 19 identifies the position of the ride-sharing vehicle 10. The vehicle position notification unit 20 notifies the identified position of the ride-sharing vehicle 10 to the user. Accordingly, the user can identify the ride-sharing vehicle 10, and can easily board the ride-sharing vehicle 10 even in a case where another vehicle is present around the ride-sharing vehicle 10.

As described above, the vehicle terminal 3 is composed of the user terminal 2 carried by the driver of the ride-sharing vehicle 10. Accordingly, the vehicle ride-sharing assist system 1 can be used even if the ride-sharing vehicle 10 is not provided with a camera or a recorder.

Concrete embodiments of the present invention have been described in the foregoing, but the present invention should not be limited by the foregoing embodiments and various modifications and alterations are possible. For example, a specific configuration and arrangement of each member and each portion thereof, quantity, steps, and the like can be changed as appropriate within the scope of the present invention. Further, not all of the structural elements shown in the above embodiments are necessarily indispensable and they may be selectively adopted as appropriate.

### Glossary of Terms

1: vehicle ride-sharing assist system
2: user terminal
3: vehicle terminal
4: network
5: host server
6: vehicle navigation system
7: image database
8: sound database
10: ride-sharing vehicle
11: processing unit
12: GPS (position estimation unit)
13: terminal communication unit
14: image capturing device (information acquiring unit)
15: recording device (information acquiring unit)
16: display
17: speaker
18: vehicle response request unit
19: vehicle position identification unit
20: vehicle position notification unit
21: operation unit
22: user side notification/operation unit
23: vehicle side notification/operation unit
28: user response request unit
29: user position identification unit
30: user position notification unit
31: server communication unit
32: ride-sharing information management unit
33: user position estimation unit
34: vehicle position estimation unit

1. A vehicle ride-sharing assist system for assisting in identification of a user to board a ride-sharing vehicle at a pickup point, the vehicle ride-sharing assist system comprising:
a wirelessly communicable user terminal configured to be carried by the user;
a wirelessly communicable vehicle terminal mounted on the ride-sharing vehicle; and
a server wirelessly communicable with the user terminal and the vehicle terminal and including a database,
wherein the server further includes a proximity notification unit configured to generate a proximity notification signal so as to transmit the proximity notification signal to the user terminal and the vehicle terminal when a distance between the user and the ride-sharing vehicle becomes equal to or less than a prescribed value,
the vehicle terminal includes a user response request unit configured to generate a user response request signal so as to transmit the user response request signal to the user terminal when the vehicle terminal receives the proximity notification signal, the user response request signal requesting a specific motion of the user or a specific operation of the user terminal,
the user terminal includes a user side notification unit configured to notify the user of the specific motion thereof according to the user response request signal transmitted from the vehicle terminal or a user side operation unit configured to cause the user terminal to perform the specific operation thereof according to the user response request signal transmitted from the vehicle terminal, and
the vehicle terminal further includes a user position identification unit configured to detect the specific motion of the user or the specific operation of the user terminal and identify a position of the user based on the specific motion of the user or the specific operation of the user terminal and a user position notification unit configured to notify the identified position of the user to a driver of the ride-sharing vehicle.

2. The vehicle ride-sharing assist system according to claim 1, wherein the vehicle terminal further includes a vehicle side information acquiring unit including an image capturing device or a recording device, and
the user position identification unit is configured to detect the specific motion of the user or the specific operation of the user terminal based on information acquired by the vehicle side information acquiring unit.

3. The vehicle ride-sharing assist system according to claim 2, further comprising an image database configured to store positional information and surrounding image information related to the positional information or a sound database configured to store the positional information and environmental sound information related to the positional information,
wherein the user terminal further includes a user side information acquiring unit including an image capturing device or a recording device,
the server further includes a vehicle position estimation unit configured to estimate a position of the ride-sharing vehicle by referring to the image database or the sound database based on the information acquired by the vehicle side information acquiring unit and a user position estimation unit configured to estimate the position of the user by referring to the image database or the sound database based on information acquired by the user side information acquiring unit, and
the proximity notification unit is configured to generate the proximity notification signal when the distance between the user and the ride-sharing vehicle based on respective estimation results of the user position estimation unit and the vehicle position estimation unit becomes equal to or less than the prescribed value.

4. The vehicle ride-sharing assist system according to claim 1, wherein the user terminal further includes a GPS unit as a position estimation unit of the user corresponding to the user terminal and the vehicle terminal further includes a GPS unit as a position estimation unit of the ride-sharing vehicle corresponding to the vehicle terminal, and
the proximity notification unit is configured to generate the proximity notification signal when the distance between the user and the ride-sharing vehicle calculated based on the respective GPS units of the user terminal and the vehicle terminal becomes equal to or less than the prescribed value.

5. The vehicle ride-sharing assist system according to claim 1, wherein the vehicle terminal further includes an operation unit configured to cause the driver to designate the specific motion of the user or the specific operation of the user terminal according to a notification from the proximity notification unit, and
the user response request unit is configured to generate the user response request signal requesting the specific motion of the user or the specific operation of the user terminal designated by the driver via the operation unit.

6. The vehicle ride-sharing assist system according to claim 1, wherein the specific motion of the user or the specific operation of the user terminal includes sound generation by the user terminal or the motion of the user.

7. The vehicle ride-sharing assist system according to claim 3, wherein the specific motion of the user or the specific operation of the user terminal includes transmission of an image of the user captured by the user side information acquiring unit of the user terminal or transmission of a voice of the user recorded by the user side information acquiring unit of the user terminal.

8. The vehicle ride-sharing assist system according to claim 3, wherein the user terminal further includes a vehicle response request unit configured to generate a vehicle response request signal so as to transmit the vehicle response request signal to the vehicle terminal when the user terminal receives the proximity notification signal, the vehicle response request signal requesting a specific operation of the ride-sharing vehicle,
the vehicle terminal further includes a vehicle side notification unit configured to notify the specific operation of the ride-sharing vehicle to the driver according to the vehicle response request signal transmitted from the user terminal or a vehicle side operation unit configured to cause the ride-sharing vehicle to perform the specific operation thereof, and
the user terminal further includes a vehicle position identification unit configured to detect the specific operation of the ride-sharing vehicle and identify the position of the ride-sharing vehicle based on the specific operation of the ride-sharing vehicle and a vehicle position notification unit configured to notify the identified position of the ride-sharing vehicle to the user.

9. The vehicle ride-sharing assist system according to claim 8, wherein the vehicle position identification unit is configured to detect the specific operation of the ride-sharing vehicle based on the information acquired by the user side information acquiring unit.

10. The vehicle ride-sharing assist system according to claim 9, wherein the server further includes a ride-sharing information management unit configured to set the position estimated by the user position estimation unit as the pickup point.

11. The vehicle ride-sharing assist system according to claim 10, wherein the vehicle terminal further includes a speaker, and
the user position notification unit is configured to notify the driver of proximity of the user by a notification sound from the speaker of the vehicle terminal when a distance between the ride-sharing vehicle and the user or between the ride-sharing vehicle and the pickup point becomes equal to or less than the prescribed value.

12. The vehicle ride-sharing assist system according to claim 11, wherein the user position notification unit is configured to change volume or a tempo of the notification sound according to the distance between the ride-sharing vehicle and the user or between the ride-sharing vehicle and the pickup point.

13. The vehicle ride-sharing assist system according to claim 10, wherein the user terminal further includes a speaker, and
the vehicle position notification unit is configured to notify the user of proximity of the ride-sharing vehicle by a notification sound from the speaker of the user terminal when a distance between the user and the ride-sharing vehicle or between the user and the pickup point becomes equal to or less than the prescribed value.

14. The vehicle ride-sharing assist system according to claim 13, wherein the vehicle position notification unit is configured to change volume or a tempo of the notification sound according to the distance between the user and the ride-sharing vehicle or between the user and the pickup point.

15. The vehicle ride-sharing assist system according to claim 10, wherein the vehicle terminal further includes a display, and
the user position notification unit is configured to notify the position of the user to the driver by a map displayed on the display of the vehicle terminal when a distance between the ride-sharing vehicle and the user or between the ride-sharing vehicle and the pickup point becomes equal to or less than the prescribed value.

16. The vehicle ride-sharing assist system according to claim 10, wherein the user terminal further includes a display, and
the vehicle position notification unit is configured to notify the position of the ride-sharing vehicle to the user by a map displayed on the display of the user terminal when a distance between the user and the ride-sharing vehicle or between the user and the pickup point becomes equal to or less than the prescribed value.

17. The vehicle ride-sharing assist system according to claim 15, wherein the user position notification unit is configured to create a route to the user or the pickup point and notify the position of the user to the driver by displaying the created route on the display of the vehicle terminal, the route being created based on the position of the ride-sharing vehicle estimated by the vehicle position estimation unit and the position of the user estimated by the user position estimation unit or based on the position of the ride-sharing vehicle estimated by the vehicle position estimation unit and the pickup point.

18. The vehicle ride-sharing assist system according to claim 1, wherein the vehicle terminal is composed of the user terminal carried by the driver.
